(19) United States
(12) Patent Application Publication
(10) Pub. No.: US 2004/0156779 A1
(43) Pub. Date: Aug. 12, 2004

(54) Way to split oxygen and hydrogen of water with zero energy input

(76) Inventor: Hanna Albert Awad, Ajaltoun (LB)

Correspondence Address: Hanna Albert Awad, Ajoltoun Kesrouan Lebanaon, Ajoltoun, LB

(21) Appl. No.: 10/361,902

(22) Filed: Feb. 11, 2003

(51) Int. Cl. C01B 3/06

(52) U.S. Cl. 423/658.2

(57) ABSTRACT

This invention consists of splitting oxygen and hydrogen of water by sucking water in form of vapor (the pressure above water is so low that the water boils at atmospheric temperature). Then, the vapor is further sucked (with lower pressure than the first cylinder). Then the vapor is compressed with a pressure higher than both cylinders because piston 2 has the largest displacement.

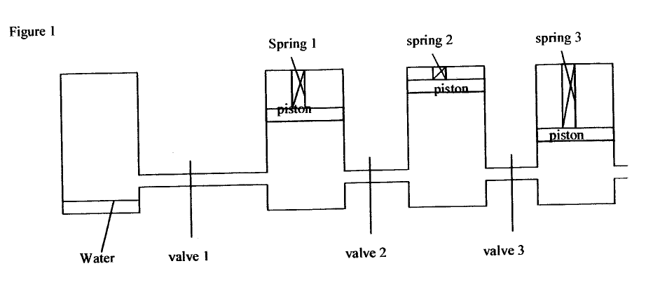

The constant of the spring and its displacement of spring 2 is higher than both spring 2 and spring 3. The constant of the spring and its displacement of spring 1 is between spring 2 and spring 3 The sum of the displacements of spring 1 and spring 3 must be less than the displacement of spring 2. And the sum of the spring constants of spring 1 and 3 must be less than the spring constant of spring 2. The three cylinders can be repeated (three cylinders linked to another three cylinders, etc . . . ) until we have a pressure at the last cylinder that will liquefy hydrogen (the liquefaction point of hydrogen is different from the liquefaction point of oxygen).

Then we extract hydrogen (by pressure) and use it as a fuel.

### CIRCUMSTANCES AND DATE OF CONCEPTION

It is an extension to invention which has the application Ser. No. 09/886,862, filing date Nov. 20, 2001, applicant: hanna albert awad and have the title: concepts and their applications, pumps, compressors working on valves and engines working on those compressors.

I have asked to appeal for this previous application.

Drawing: valve 1 open, valve 2 and 3 closed.

Then, valve 2 open, valve 1 and 3 closed.

Then valve 3 open, valve 1 and 2 closed.

Then repeat.

This invention consists of splitting oxygen and hydrogen of water by sucking water in form of vapor (the pressure above water is so low that the water boils at atmospheric temperature). Then, the vapor is further sucked (with lower pressure than the first cylinder). Then the vapor is compressed with a pressure higher than both cylinders because piston 2 has the largest displacement.

The constant of the spring and its displacement of spring 2 is higher than both spring 2 and spring 3. The constant of the spring and its displacement of spring 1 is between spring 2 and spring 3 The sum of the displacements of spring 1 and spring 3 must be less than the displacement of spring 2. And the sum of the spring constants of spring 1 and 3 must be less than the spring constant of spring 2. The three cylinders can be repeated (three cylinders linked to another three cylinders, etc. . . . )until we have a pressure at the last cylinder that will liquefy hydrogen (the liquefaction point of hydrogen is different from the liquefaction point of oxygen).

Then we extract hydrogen (by pressure) and use it as a fuel.

### DESCRIPTION OF THE INVENTION

PURPOSE: to split oxygen and hydrogen of water without energy consumption.

PARTS: the cylinders, valves, springs and pistons shown in the figures.

USE: it is used to back filling the mix of oxygen and hydrogen without energy consumption.

NOVEL FEATURES: the system is all new and unkown.

ADVANTAGES with zero energy input we can have hydrogen as a fuel and use oxygen for other purposes.

### Testing Results

This system is very easy to assemble. And the results came perfect.

I claim the right for using this system in any purpose or for any use:

1. I claim the write for producing oxygen and hydrogen this way including sales, as a use for cars, electricity plants or any other energy or power production.
